(19) United States
(12) Patent Application Publication
(10) Pub. No.: US 2026/0045988 A1
(43) Pub. Date: Feb. 12, 2026

(54) CODEBOOK SUBSET RESTRICTION BASED ON NUMBER OF LAYERS ASSOCIATED WITH A BEAM

(71) Applicant: Lenovo (Singapore) Pte. Limited, Singapore (SG)

(72) Inventor: Ahmed Hindy, Aurora, IL (US)

(73) Assignee: Lenovo (Singapore) Pte. Limited, Singapore (SG)

(21) Appl. No.: 18/796,127

(22) Filed: Aug. 6, 2024

(51) Int. Cl. H04B 7/06

(52) U.S. Cl. CPC H04B 7/0617; H04B 7/0626; H04B 7/0639

(57) ABSTRACT

Various aspects of the present disclosure relate to codebook subset restriction (CBSR) based on number of layers associated with a beam. A user equipment (UE) receives a channel state information (CSI) report setting that comprises an indication of a codebook subset restriction (CBSR). An initial amplitude value of a first restricted beam of a set of restricted beams is based at least in part on the CBSR. The UE adjusts the initial amplitude value of the first restricted beam based at least in part on a number of layers associated with the first restricted beam.

### TECHNICAL FIELD

The present disclosure relates to wireless communications, and more specifically to codebook subset restriction enhancements.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives a channel state information (CSI) report setting, wherein the CSI report setting comprises an indication of a codebook subset restriction (CBSR), wherein an initial amplitude value of a first restricted beam of a set of restricted beams is based at least in part on the CBSR; and adjusts the initial amplitude value of the first restricted beam based at least in part on a number of layers associated with the first restricted beam.

In some implementations of the method and apparatuses described herein, the UE receives a reference signal (RS) over a non-zero power (NZP) CSI-RS resource based at least in part on the CSI report setting; generates a CSI report including a precoding matrix indicator (PMI), wherein a value of the PMI is based at least in part on the NZP CSI-RS resource and the CBSR; and transmits the CSI report including the PMI. Additionally or alternatively, the set of restricted beams comprises at least one subset of restricted beams, and the at least one subset of restricted beams is associated with an amplitude restriction value applicable for each restricted beam in the at least one subset of restricted beams. Additionally or alternatively, to adjust the initial amplitude value, the UE applies a scaling factor to the initial amplitude value of the first restricted beam, wherein the scaling factor corresponds to an amplitude restriction value, and wherein the scaling factor comprises a non-negative value less than or equal to one. Additionally or alternatively, wherein the first restricted beam is associated with two layers of a PMI associated with a codebook for CSI feedback and the UE adjusts the initial amplitude value of the first restricted beam by scaling the amplitude value of the first restricted beam by an inverse of a square root value of 2; and leaves a second restricted beam associated with a single layer of a PMI associated with the codebook for CSI feedback unadjusted. Additionally or alternatively, wherein the first restricted beam is associated with a single layer of a PMI associated with a codebook for CSI feedback and the UE: adjusts the initial amplitude of the first restricted beam by scaling the amplitude value of the first restricted beam by a square root value of 2; and does leaves a second restricted beam associated with two layers of a PMI associated with the codebook for CSI feedback unadjusted. Additionally or alternatively, the UE: identifies a restriction for the amplitude value of the first restricted beam based at least in part on a metric associated with the CBSR; and separately applies the restriction for the amplitude value of the first restricted beam on each frequency band of one or more frequency bands associated with a PMI. Additionally or alternatively, a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

Some implementations of the method and apparatuses described herein may further include a processor for wireless communication. The processor receives a CSI report setting, wherein the CSI report setting comprises an indication of a CBSR, wherein an initial amplitude value of a first restricted beam of a set of restricted beams is based at least in part on the CBSR; and adjusts the initial amplitude value of the first restricted beam based at least in part on a number of layers associated with the first restricted beam.

In some implementations of the method and apparatuses described herein, the processor to receives a RS over a NZP CSI-RS resource based at least in part on the CSI report setting; generates a CSI report including a PMI, wherein a value of the PMI is based at least in part on the NZP CSI-RS resource and the CBSR; and transmits the CSI report including the PMI. Additionally or alternatively, Additionally or alternatively, the set of restricted beams comprises at least one subset of restricted beams, and wherein the at least one subset of restricted beams is associated with an amplitude restriction value applicable for each restricted beam in the at least one subset of restricted beams. Additionally or alternatively, to adjust the initial amplitude value, the processor applies a scaling factor to the initial amplitude value of the first restricted beam, wherein the scaling factor corresponds to an amplitude restriction value, and wherein the scaling factor comprises a non-negative value less than or equal to one. Additionally or alternatively, the first restricted beam is associated with two layers of a PMI associated with a codebook for CSI feedback and the processor adjusts the initial amplitude value of the first restricted beam by scaling the amplitude value of the first restricted beam by an inverse of a square root value of 2; and does leaves a second restricted beam associated with a single layer of a PMI associated with the codebook for CSI feedback unadjusted. Additionally or alternatively, wherein the first restricted beam is associated with a single layer of a PMI associated with a codebook for CSI feedback and the processor adjusts the initial amplitude of the first restricted beam by scaling the amplitude value of the first restricted beam by a square root value of 2; and does leaves a second restricted beam associated with two layers of a PMI associated with the codebook for CSI feedback unadjusted. Additionally or alternatively, the processor identifies a restriction for the amplitude value of the first restricted beam based at least in part on a metric associated with the CBSR; and separately applies the restriction for the amplitude value of the first restricted beam on each frequency band of one or more frequency bands associated with a PMI.

Some implementations of the method and apparatuses described herein may further include a base station for wireless communication. The base station transmits a CSI report setting, wherein the CSI report setting comprises an indication of a CBSR on a PMI; transmits a RS over a NZP CSI-RS resource based at least in part on the CSI report setting; and receives a CSI report including a PMI, wherein a value of the PMI is based at least in part on the NZP CSI-RS resource and the CBSR, and wherein an amplitude value associated with the CBSR has been adjusted based at least in part on a number of layers associated with a beam in a set of restricted beams.

In some implementations of the method and apparatuses described herein, the CBSR comprises the set of restricted beams configured by the base station, wherein the set of restricted beams is associated with a set of restriction values, and wherein the set of restriction values corresponds to a codebook of amplitude restriction values.

Some implementations of the method and apparatuses described herein may further include a method performed by a UE, the method comprising: receiving a CSI report setting, wherein the CSI report setting comprises an indication of a CBSR, wherein an initial amplitude value of a first restricted beam of a set of restricted beams is based at least in part on the CBSR; and adjusting the initial amplitude value of the first restricted beam based at least in part on a number of layers associated with the first restricted beam.

In some implementations of the method and apparatuses described herein, the method further comprises: receiving a NZP CSI-RS resource based at least in part on the CSI report setting; generating a CSI report including a PMI value, wherein the PMI value is based at least in part on the NZP CSI-RS resource and the CBSR; and transmitting the CSI report including the PMI. Additionally or alternatively, the adjusting the initial amplitude value of the first restricted beam comprises applying a scaling factor to the initial amplitude value of the first restricted beam, wherein the scaling factor corresponds to an amplitude restriction value, and wherein the scaling factor comprises a non-negative value less than or equal to one.

### BRIEF DESCRIPTION OF THE DRAWINGS

FIG. 1 illustrates an example of a wireless communications system in accordance with aspects of the present disclosure.

FIGS. 2 through 5 illustrate examples of matrices as related to channel state information reporting using mixed reference signal types.

FIG. 6 illustrates an example of aperiodic trigger state defining a list of CSI Report Settings.

FIG. 7 illustrates an example of aperiodic trigger state.

FIG. 8 illustrates an example of RRC configuration for a NZP CSI-RS Resource.

FIG. 9 illustrates an example of RRC configuration for a CSI interference management (CSI-IM) Resource.

FIG. 10 illustrates an example of CSI reporting.

FIGS. 11 through 13 illustrate example information elements (IEs) in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of a network equipment (NE) in accordance with aspects of the present disclosure.

FIG. 17 illustrates a flowchart of a method performed by a UE in accordance with aspects of the present disclosure.

FIG. 18 illustrates a flowchart of a method performed by a NE in accordance with aspects of the present disclosure.

### DETAILED DESCRIPTION

In 3rd Generation Partnership Project (3GPP) new radio (NR) networks, CSI feedback in frequency-division duplexing (FDD) networks is reported by the UE to the network (e.g., base station), where the CSI feedback is compressed via transformation of the channel over the spatial domain, frequency domain, or both, with pre-determined sets of spatial and frequency basis vectors, respectively. One feature associated with CSI feedback for precoding is CBSR, a functionality that allows the network to restrict the codebook design at the UE to avoid specific beamforming directions that would amplify the inter-cell interference at other UEs. In legacy codebook design, the CBSR is in the form of restriction of indices of discrete Fourier transform (DFT) beams associated with the DFT-based spatial transformation in legacy NR codebooks. Discussed herein is a CBSR mechanism with soft amplitude restriction, e.g., a beam may be restricted via an attenuation of the power with respect to unrestricted beams. More specifically, the attenuation of restricted beams is based on a number of layers (the number of data streams) in which the restricted beam is used if more than one layer is reported within the codebook corresponding to PMI. The number of layers associated with a beam is also referred to as the rank of the beam. Additionally or alternatively, a UE is expected to adjust a higher-layer configured amplitude restriction corresponding to CBSR based on a selection of the spatial domain (SD) basis indices corresponding to the spatial beams associated with the PMI of the codebook.

Using the techniques discussed herein, the network (e.g., a base station) configures a UE to restrict a subset of a set of beams by a given amplitude attenuation. This configuring is done, for example, by transmitting an indication of a CBSR to the UE. The UE determines the number of layers (the number of data streams) associated with a beam in the subset of beams (e.g., the number of different data streams being transmitted using the beam). The UE adjusts the amplitude attenuation values indicated in the CBSR for the beam based at least in part on the number of layers associated with the beam, so that, for example, beams having a larger number of associated layers are attenuated more than beams having a smaller number of associated layers.

The techniques discussed herein improve upon CBSR techniques that use hard amplitude restriction. Using such techniques the network configures the UE with a CBSR framework that resembles the Type-I CBSR format with hard CBSR restriction, i.e., an SD basis index (e.g., a beam is either prohibited or allowed to be transmitted). Using CBSR with hard amplitude restriction can be too restrictive and does not fit scenarios where an attenuation of the amplitude of a beam suffices to mitigate inter-cell interference. The techniques discussed herein overcome these issues by using soft amplitude restriction.

The techniques discussed herein also improve upon other solutions that use a legacy CBSR framework with soft amplitude restriction. Using these solutions, the network configures the UE with a CBSR framework that resembles the Type-II CBSR format with soft CBSR restriction, i.e., a beam can be attenuated with a non-zero fraction to gradually reduce inter-cell interference caused by the beam. Such legacy solutions included having a set of beams that were commonly used for all layers, so all of the layers have access to all of the beams. In such a solution, two restricted beams could be used in unequal numbers of layers, so the proper amount of soft amplitude restriction to use for a particular restricted beam could not be calculated. However, newer and future versions of wireless communications systems are expected to support allowing an exclusive association between a beam and a layer (e.g., as used in a Type-I Rel-19 codebook). The techniques discussed herein support allowing an exclusive association between a beam and a layer, allowing the proper amount of soft amplitude restriction to use for a particular beam to be calculated based on the number of layers associated with the beam.

Aspects of the present disclosure are described in the context of a wireless communications system.

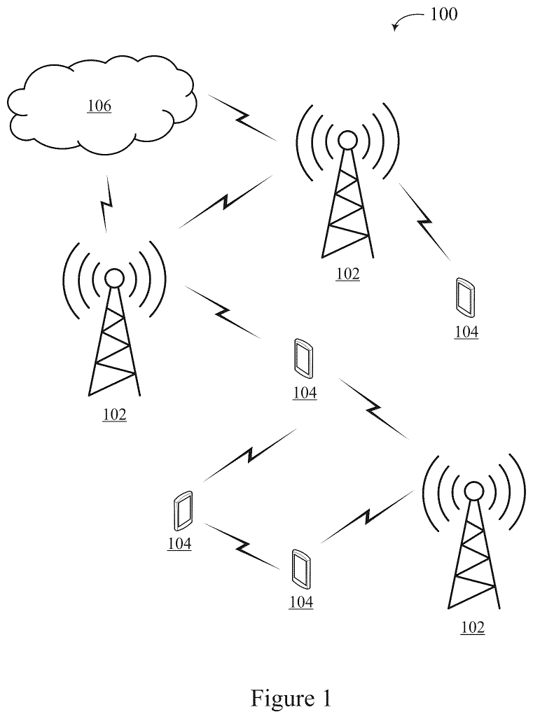

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Using the techniques discussed herein, a NE 102 (e.g., a base station) configures a UE 104 to restrict a subset of a set of beams by a given amplitude attenuation. This configuring is done, for example, by the NE 102 transmitting an indication of a CBSR to the UE 104. The UE 104 can support multiple layers (e.g., multiple data streams) concurrently and different beams can be associated with different numbers of layers. The UE 104 determines the number of layers associated with a beam in the subset of beams (e.g., the number of different data streams being transmitted using the beam). The UE 104 adjusts the amplitude attenuation values indicated in the CBSR for the beam based at least in part on the number of layers associated with the beam, so that, for example, beams having a larger number of associated layers are attenuated more than beams having a smaller number of associated layers.

Communication between devices discussed herein, such as between UEs 104 and NEs 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

Reference is made herein to receiving or transmitting data, information, messages, and so forth. It is to be appreciated that other terms may be used interchangeably with receiving or transmitting, such as communicating, outputting, forwarding, retrieving, obtaining, and so forth.

Note that for Rel-16 eType-II CB and Rel-17 FeType-II PS CB, the reference amplitude value and the differential amplitude value are quantized as follows. Reference amplitude for weaker polarization takes on values

$$\{ 1 , {( \frac{1}{2} )}^{\frac{1}{4}} , {( \frac{1}{4} )}^{\frac{1}{4}} , … , {( \frac{1}{{2}^{14}} )}^{\frac{1}{4}} \} ,$$

i.e., −1.5 dB step size. Coefficient amplitudes take on values

$$\{ 1 , {( \frac{1}{2} )}^{\frac{1}{2}} , {( \frac{1}{4} )}^{\frac{1}{2}} , … , {( \frac{1}{{2}^{7}} )}^{\frac{1}{4}} \} ,$$

i.e., −3 dB step size. Within the restricted beam groups, dealing with unrestricted beams (beams with unit amplitude) and fully restricted beams (beams with zero amplitude) is straightforward, since the beam would then be fully utilized/abandoned when designing the precoder. However, dealing with partially restricted beams (beams with positive amplitude less than unity) is non-trivial. For partial restriction, CBSR is applied to the average channel gain associated with different frequency-domain transformation.

The techniques discussed herein support various NR codebook types, such as the NR codebook types discussed in 3GPP technical specification (TS) 38.214, “Physical layer procedures for data,” December 2022. A summary of these techniques follows.

One codebook type is a NR Rel. 15 Type-II Codebook. Assume the NE 102 is equipped with a two-dimensional (2D) antenna array with N₁, N₂ antenna ports per polarization placed horizontally and vertically and communication occurs over N3 precoder matrix indicator (PMI) sub-bands. A PMI subband consists of a set of resource blocks, each resource block consisting of a set of subcarriers. In such case, 2N₁N₂ CSI-RS ports are utilized to enable downlink (DL) channel estimation with high resolution for NR Rel. 15 Type-II codebook. In order to reduce the uplink (UL) feedback overhead, a DFT-based CSI compression of the spatial domain is applied to L dimensions per polarization, where L<N₁N₂. In the sequel the indices of the 2L dimensions are referred as the Spatial Domain (SD) basis indices. The amplitude and phase values of the linear combination coefficients for each sub-band are fed back to the NE 102 as part of the CSI report. The 2N₁N₂×N₃ codebook per layer l takes on the form

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that 0, 02 oversampling factors are assumed for the 2D DFT matrix from which matrix B is drawn. Note that W₁ is common across all layers. W_{2,l} is a 2L×N3 matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,l} are independent for different layers.

One codebook type is a NR Rel. 15 Type-II Port Selection codebook. For Type-II Port Selection codebook, only K (where K≤2N₁N₂) beamformed CSI-RS ports are utilized in DL transmission, in order to reduce complexity. The K×N₃ codebook matrix per layer takes on the form

$${W}_{l} = {W}_{1}^{PS} {W}_{2 , l} .$$

Here, W₂ follow the same structure as the conventional NR Rel. 15 Type-II Codebook, and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mo d ( {m}_{PS} {d}_{PS} , K / 2 )}^{( K / 2 )} & {e}_{mo d ( {m}_{PS} {d}_{PS} + 1 , K / 2 )}^{( K / 2 )} & … & {e}_{mo d ( {m}_{PS} {d}_{PS} + L - 1 , K / 2}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

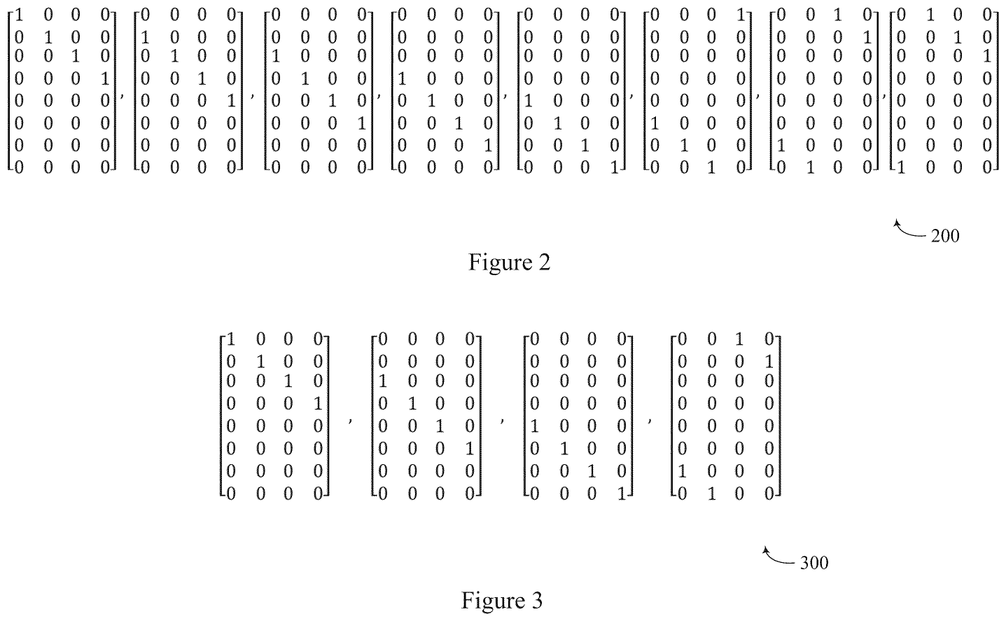

FIG. 2 illustrates an example 200 of matrices as related to channel state information reporting using mixed reference signal types. For K=16, L=4 and d_{PS}=1, the 8 possible realizations of E corresponding to m_{PS}={0, 1, . . . , 7} are illustrated in the example 200.

FIG. 3 illustrates an example 300 of matrices as related to channel state information reporting using mixed reference signal types. When d_{PS}=2, the 4 possible realizations of E corresponding to m_{PS}={0,1,2,3} are illustrated in the example 300.

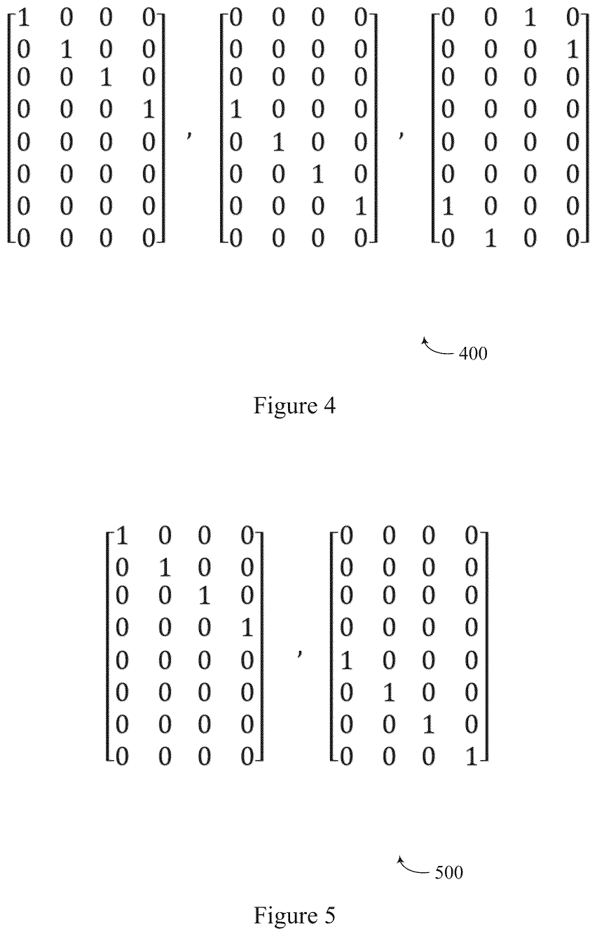

FIG. 4 illustrates an example 400 of matrices as related to channel state information reporting using mixed reference signal types. When d_{PS}=3, the 3 possible realizations of E corresponding of m_{PS}={0,1,2} are illustrated in the example 400.

FIG. 5 illustrates an example 500 of matrices as related to channel state information reporting using mixed reference signal types. When d_{PS}=4, the 2 possible realizations of E corresponding of m_{PS}={0,1} are illustrated in the example 500.

With respect to FIGS. 2-5, to summarize, m_{PS} parametrizes the location of the first 1 in the first column of E, whereas d_{PS} represents the row shift corresponding to different values of m_{PS}.

One codebook type is a NR Rel. 15 Type-I codebook. NR Rel. 15 Type-I codebook is the baseline codebook for NR, with a variety of configurations. The most common utility of Rel. 15 Type-I codebook is a special case of NR Rel. 15 Type-II codebook with L=1 for rank indicator (RI)=1,2, where a phase coupling value is reported for each sub-band, i.e., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁= . . . =ϕ_{N}_{₃}₋₁, i.e., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only.

One codebook type is a NR Rel. 16 Type-II codebook. Assume the NE 102 is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the amplitude and phase values of a subset of the delay-domain coefficients are selected and fed back to the NE 102 as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} \\ {v}_{l , m} = {[ \begin{matrix}{u}_{m} & {e}^{j \frac{2 π l}{{O}_{1} {N}_{1}}} {u}_{m} & … & {e}^{j \frac{2 πl ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ \begin{matrix}{l}_{i} = {O}_{1} {n}_{1}^{( i )} + {q}_{1} , & 0 \leq {n}_{1}^{( i )} < {N}_{1} , 0 \leq {q}_{1} < {O}_{1} ,\end{matrix} \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

where the superscript ^{T} denotes a matrix transposition operation. Note that O₁, O₂ oversampling factors are assumed for the 2D DFT matrix from which matrix B is drawn. Note that W₁ is common across all layers. W_{f,l} is an N₃×M matrix (M<N₃) with columns selected from a critically-sampled size-N3 DFT matrix, as follows

$$\begin{matrix}\begin{matrix}{W}_{f , l} = [ \begin{matrix}{f}_{{k}_{0}} & {f}_{{k}_{1}} & … & {f}_{{k}_{M - 1}}\end{matrix} ] , & 0 \leq {k}_{i} \leq {N}_{3} - 1 ,\end{matrix} \\ {f}_{k} = [ \begin{matrix}1 & {e}^{- j \frac{2 π k}{{N}_{3}}} & … & {e}^{{- j \frac{2 π k ( {N}_{3} - 1 )}{{N}_{3}} ]}^{T}}\end{matrix} .\end{matrix}$$

Only the indices of the L selected columns of B are reported, along with the oversampling index taking on O₁O₂ values. Similarly, for W_{f,l}, only the indices of the M selected columns out of the predefined size-N3 DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, and W_{f,l} are selected independently for different layers. Amplitude and phase values of an approximately β fraction of the 2LM available coefficients are reported to the NE 102 (β<1) as part of the CSI report. Coefficients with zero magnitude are indicated via a layer-specific bitmap, with the largest amplitude value (strongest coefficient) set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients of a theoretical design.

One codebook type is a NR Rel. 16 Type-II Port Selection codebook. For Type-II Port Selection codebook, only K (where K≤2N₁N₂) beamformed CSI-RS ports are utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} ,$$

Here, \tilde{W}_{2,l} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

One codebook type is a NR Rel. 17 Type-II Port Selection Codebook. Rel. 17 Type-II Port Selection codebook follows a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} ,$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.

$$⌈ {log}_{2} ( \begin{matrix}{N}_{1} {N}_{2} \\ K / 2\end{matrix} ) ⌉ bits$$

are used to identify the K/2 selected ports per polarization, where this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

For codebook reporting, the codebook report is partitioned into two parts based on the priority of information reported. Each part is encoded separately (Part 1 has a possibly higher code rate). Below the parameters for NR Rel. 16 Type-II codebook are listed only.

The content of the CSI report includes Part 1 and Part 2. Part 1 includes the RI plus the channel quality indicator (CQI) plus the total number of coefficients. Part 2 includes the SD basis indicator plus the FD basis indicator/layer plus the Bitmap/layer plus the Coefficient Amplitude info/layer plus the Coefficient Phase info/layer plus the Strongest coefficient indicator/layer. Furthermore, Part 2 CSI can be decomposed into sub-parts each with different priority (higher priority information listed first). Such partitioning is used to allow dynamic reporting size for codebook based on available resources in the uplink phase.

Also Type-II codebook is based on aperiodic CSI reporting, and only reported in physical uplink shared channel (PUSCH) via downlink control information (DCI) triggering (one exception). Type-I codebook can be based on periodic CSI reporting physical uplink control channel (PUCCH) or semi-persistent CSI reporting (PUSCH or PUCCH) or aperiodic reporting (PUSCH).

With respect to triggering aperiodic CSI reporting on PUSCH, the UE reports the needed CSI information for the network using the CSI framework in NR Release 15. The triggering mechanism between a report setting and a resource setting can be summarized in Table 2 below, which refers to medium access control element (MAC CE), semi-persistent (SP), and aperiodic (AP).

TABLE 2

| | | Periodic CSI | SP CSI | AP CSI |
|---|---|---|---|---|
| | | reporting | reporting | Reporting |
| Time Domain | Periodic | RRC | MAC CE (PUCCH) | DCI |
| Behavior of | CSI-RS | configured | DCI (PUSCH) | |
| Resource | SP | Not | MAC CE (PUCCH) | DCI |
| Setting | CSI-RS | Supported | DCI (PUSCH) | |
| | AP | Not | Not Supported | DCI |
| | CSI-RS | Supported | | |

Moreover, all associated Resource Settings for a CSI Report Setting need to have same time domain behavior. Periodic CSI-RS/IM resource and CSI reports are always assumed to be present and active once configured by RRC. Aperiodic and semi-persistent CSI-RS/IM resources and CSI reports needs to be explicitly triggered or activated. Aperiodic CSI-RS/IM resources and aperiodic CSI reports, the triggering is done jointly by transmitting a DCI Format 0-1. Semi-persistent CSI-RS/IM resources and semi-persistent CSI reports are independently activated.

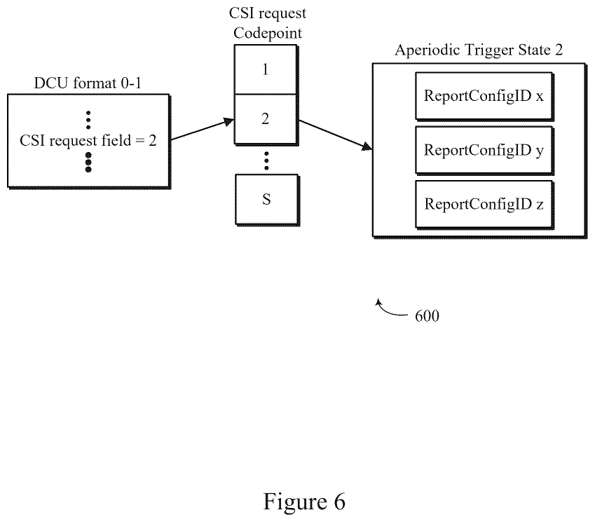

For aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC (see FIG. 6). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

FIG. 6 illustrates an example 600 of aperiodic trigger state defining a list of CSI Report Settings.

When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition.

For aperiodic NZP CSI-RS, the quasi co-location (QCL) source to use is also configured in the aperiodic trigger state. The UE assumes that the resources used for the computation of the channel and interference can be processed with the same spatial filter i.e. quasi-co-located with respect to “QCL-TypeD.”

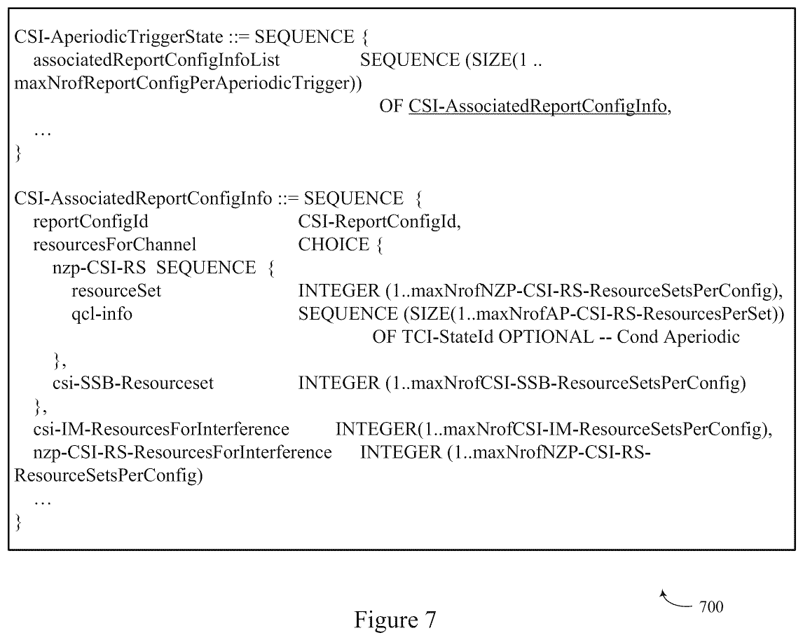

FIG. 7 illustrates an example 700 of aperiodic trigger state. The example 700 illustrates that aperiodic trigger state indicates the resource set and QCL information.

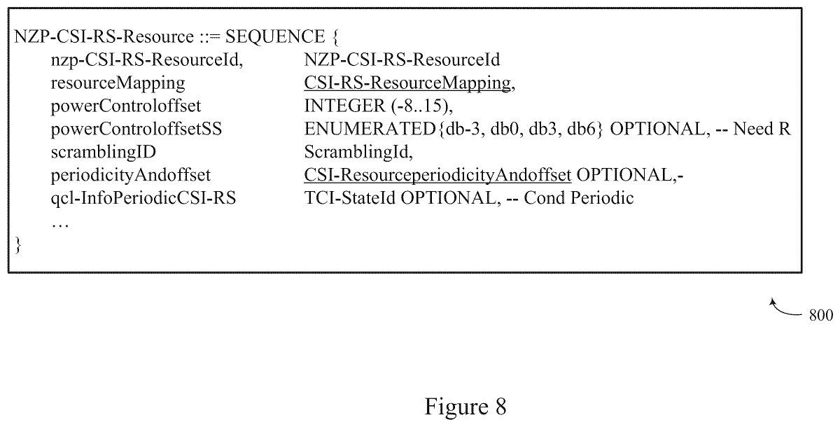

FIG. 8 illustrates an example 800 of RRC configuration for a NZP CSI-RS Resource.

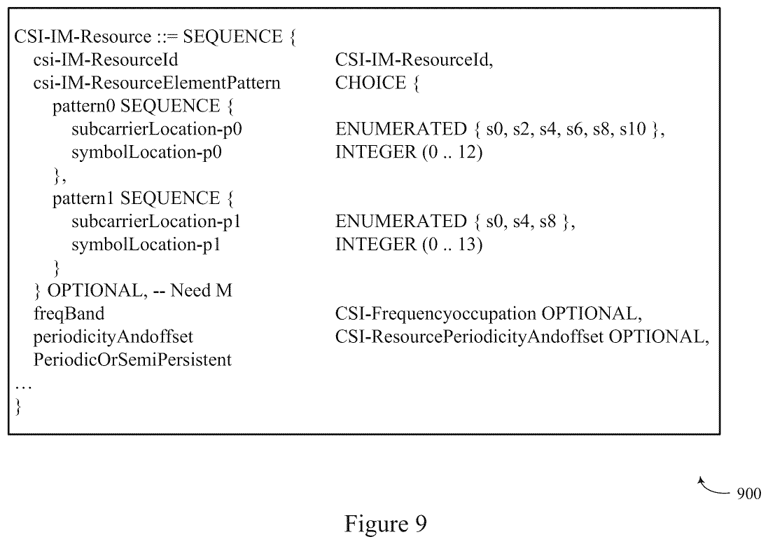

FIG. 9 illustrates an example 900 of RRC configuration for a CSI-IM Resource.

For aperiodic CSI reporting, PUSCH-based reports are divided into two CSI parts: CSI Part 1 and CSI Part 2. The reason for this is that the size of CSI payload varies significantly, and therefore a worst-case uplink control information (UCI) payload size design would result in large overhead.

CSI Part 1 has a fixed payload size (and can be decoded by the NE 102 without prior information) and contains the following: RI (if reported), CSI-RS resource index (CRI) (if reported) and CQI for the first codeword; number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4.

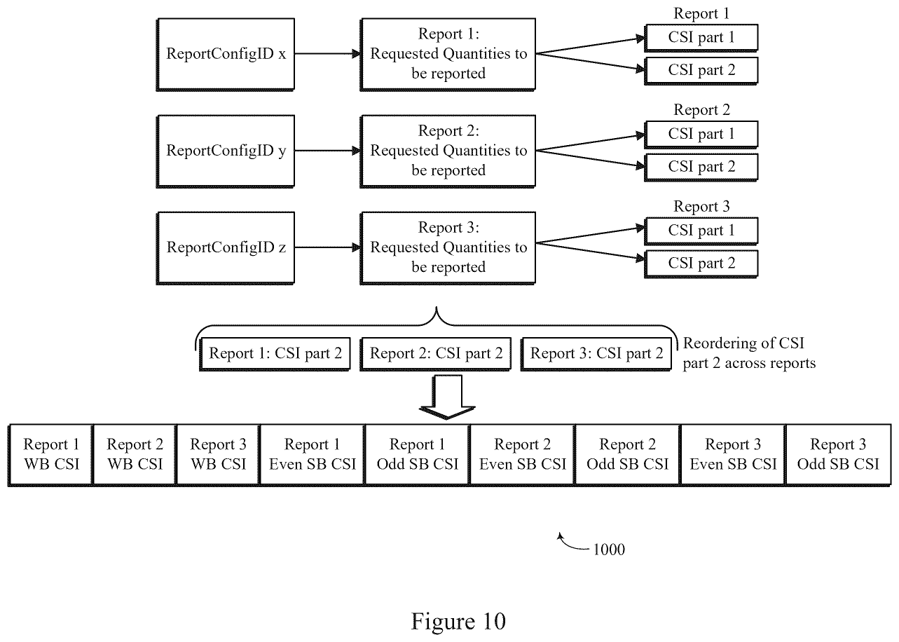

FIG. 10 illustrates an example 1000 of CSI reporting. The example 1000 illustrates the ordering of the aperiodic CSI reporting for CSI part 2 if the aperiodic trigger state indicated by DCI format 0_1 defines 3 report settings x, y, and z. The example 1000 is a partial CSI omission for Rel. 15 PUSCH-Based CSI.

As mentioned earlier, CSI reports are prioritized according to: 1) time-domain behavior and physical channel, where more dynamic reports are given precedence over less dynamic reports and PUSCH has precedence over PUCCH; 2) CSI content, where beam reports (i.e., L1 references signal received power (L1-RSRP) reporting) has priority over regular CSI reports; 3) the serving cell to which the CSI corresponds (in case of carrier aggregation (CA) operation), CSI corresponding to the PCell has priority over CSI corresponding to Scells; 4) the reportConfigID.

Codebook subset restriction (CBSR) has been supported for NR Rel. 15 Type-I and Type-II CSI for controlling inter-cell interference levels. In Type-I CBSR, a size N₁N₂O₁O₂ bitmap is used to indicate the restricted beam, where N₁/N₂ and O₁/O₂ indicate the number of horizontal/vertical ports and horizontal/vertical oversampling factors, respectively. Each bit in the sequence is used to restrict a certain DFT beam for a given oversampling index.

The bitmap parameter typeI-SinglePanel-codebookSubsetRestriction-i2 forms the bit sequence b₁₅, . . . , b₁, b₀ where b₀ is the least significant bit (LSB) and b₁₅ is the most significant bit (MSB). The bit bᵢ is associated with precoders corresponding to codebook index i₂=i. When bᵢ is zero, the randomly selected precoder for CQI calculation is not allowed to correspond to any precoder associated with the bit bᵢ.

In Type-II CBSR, instead of a hard restriction decision, e.g., a DFT beam within an oversampling index is either fully prohibited or unrestrictedly available, an amplitude restriction is further imposed as follows. The N₁N₂O₁O₂ candidate DFT beams are re-grouped into O₁O₂ beam groups (beams within a beam group do not necessarily belong to the same oversampling index). Beam restriction is only allowed on 4 out of the O₁O₂ beam groups, i.e.,

$$⌈ {log}_{2} {C}_{4}^{{O}_{1} {O}_{2}} ⌉ bits$$

are used to indicate the restricted beam groups. For the 4N₁N₂ restricted beams across the 4 beam groups, 2 bits are allocated per beam to indicate the restriction on the maximum allowed amplitude value from a codebook of amplitude value restrictions, where the amplitude restriction,

$$Amp . = \{ 1 , {( \frac{1}{2} )}^{\frac{1}{2}} , {( \frac{1}{4} )}^{\frac{1}{2}} , 0 \} ,$$

i.e., −3 dB step size per restriction value in power domain. Hence, 8N₁N₂ bits are required to report the amplitude restrictions for the 4 restricted beam groups based on Type-II soft restriction.

The bitmap parameter n1-n2-codebookSubsetRestriction-r16 forms the bit sequence B=B₁B₂ and configures the vector group indices g^{(k)}. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, Y_{i+pL} (p=0,1), with i∈{0, 1, . . . , L−1} corresponding to a beam index, of the coefficients associated with the vector in group g^{(k)} indexed by x₁, x₂, where the maximum amplitudes are given in Table 3 and the average coefficient amplitude is restricted as follows

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {{k}_{l , i + p L , f}^{( 3 )} ( {p}_{l , p}^{( 1 )} {p}_{l , i + p L , f}^{( 2 )} )}^{2}} \leq {γ}_{i + p L}$$

for l=1, . . . , U, is a layer index, f∈{0, 1, . . . , Mᵥ−1} is a frequency-domain basis index, and p=0,1 is a polarization index. A UE 104 that does not report the parameter softAmpRestriction-r16=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10.

TABLE 3

| | Maximum |
|---|---|
| | Average |
| Bit | Coefficient |
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Amplitude γ_{i+pL} |
| 00 | 0 |
| 01 | \sqrt{1/4} |
| 10 | \sqrt{1/2} |
| 11 | 1 |

Table 3 shows the maximum allowed average coefficient amplitudes for restricted vectors.

In the following discussions, the following notions are used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a transmission configuration indicator (TCI) state from a transmission configuration including at least two TCI states. Furthermore, the codebook type used for PMI reporting is arbitrary; flexibility for use of different codebook types, e.g., Type-II Rel. 16 codebook, Type-II Rel. 17 codebook, Type-II Rel. 18 codebook, etc. Additionally, hereafter, a CSI-RS for CSI corresponds to an NZP CSI-RS resource set with neither parameters ‘trs-info’ nor ‘repetition’ being configured.

Also in the following discussions, a matrix implies a sequence of fields of an arbitrary dimension, including an array (e.g., vector) of values, a standard 2D matrix and more generally a Q-dimensional matrix (tensor) where Q≥2 is an integer value. Furthermore, a mapping between a transport block and a codeword transmitted in DL can be based on a one-to-one mapping between the TBs and codewords. Additionally, a beam corresponds to an SD basis vector in a matrix of SD bases.

Various techniques or implementations of the techniques are discussed herein. Is to be appreciated that one or more elements or features from one or more of the described implementations may be combined.

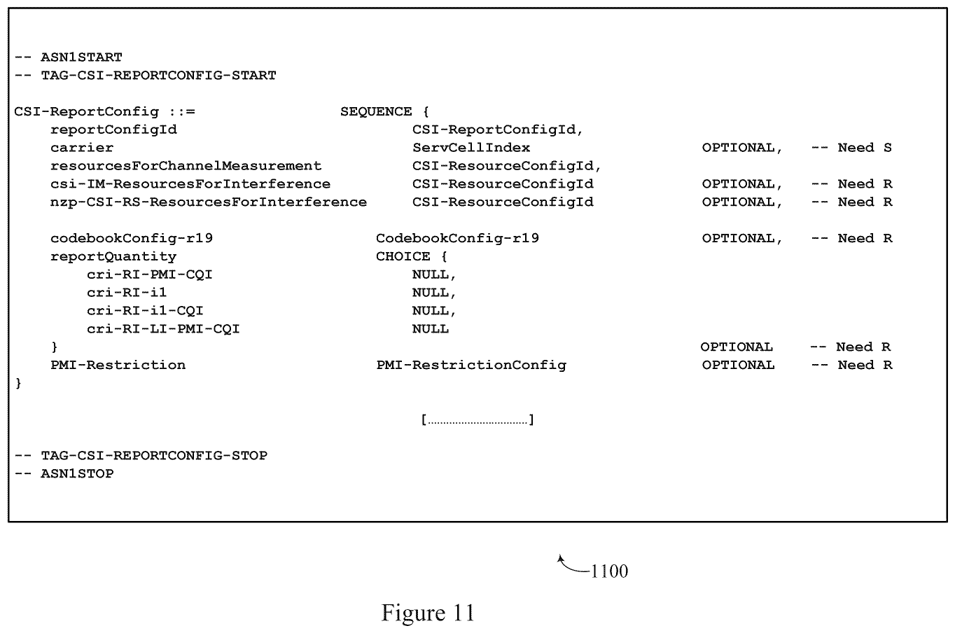

With respect to indicating a codebook subset restriction, the network (e.g., an NE 102) configures a UE 104 with a CSI feedback based on a CSI report setting, the CSI report setting including a codebook configuration that includes a codebook subset restriction. An indication of such a codebook subset restriction can be a combination of one or more of the indications described in FIGS. 11, 12, and 13.

FIG. 11 illustrates an example information element (IE) 1100 in accordance with aspects of the present disclosure. In one or more implementations, a codebook subset restriction is indicated (e.g., communicated, transmitted, sent) using a higher-layer parameter (e.g., higher than layer 2) corresponding to a CSI report setting, e.g., CSI-ReporConfig, is configured, where the CSI report setting includes a report quantity, e.g., reportQuantity, including at least a PMI value, e.g., PMI. Under these assumptions, a PMI restriction or inter-cell interference restriction parameter is further configured as part of the CSI report setting, e.g., the RRC parameter PMI-Restriction. The IE 1100 includes an example of the abstract syntax notation one (ASN.1) code for the CSI-ReportConfig CSI Report setting IE.

Additionally or alternatively, a codebook subset restriction is indicated (e.g., communicated, transmitted, sent) using a higher-layer parameter (e.g., higher than layer 2) corresponding to codebook subset restriction, e.g., the RRC parameter n1-n2-codebookSubsetRestriction-r19, is configured within the Codebook Configuration CodebookConfig IE, e.g., CodebookConfig-r19.

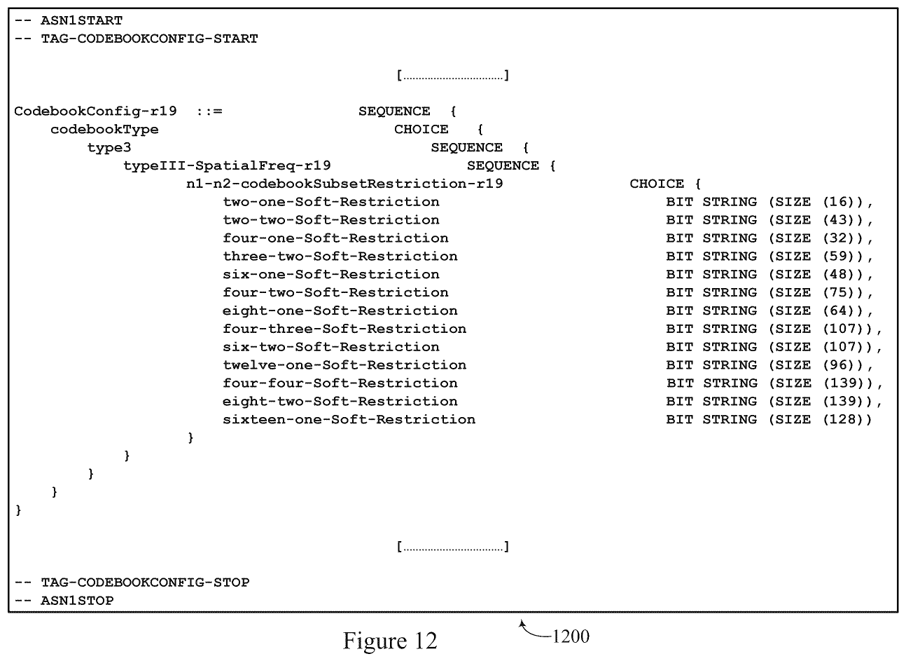

FIG. 12 illustrates an example IE 1200 in accordance with aspects of the present disclosure. The IE 1200 includes an example of the ASN.1 code corresponding to soft restriction for the CodebookConfig Codebook Configuration IE.

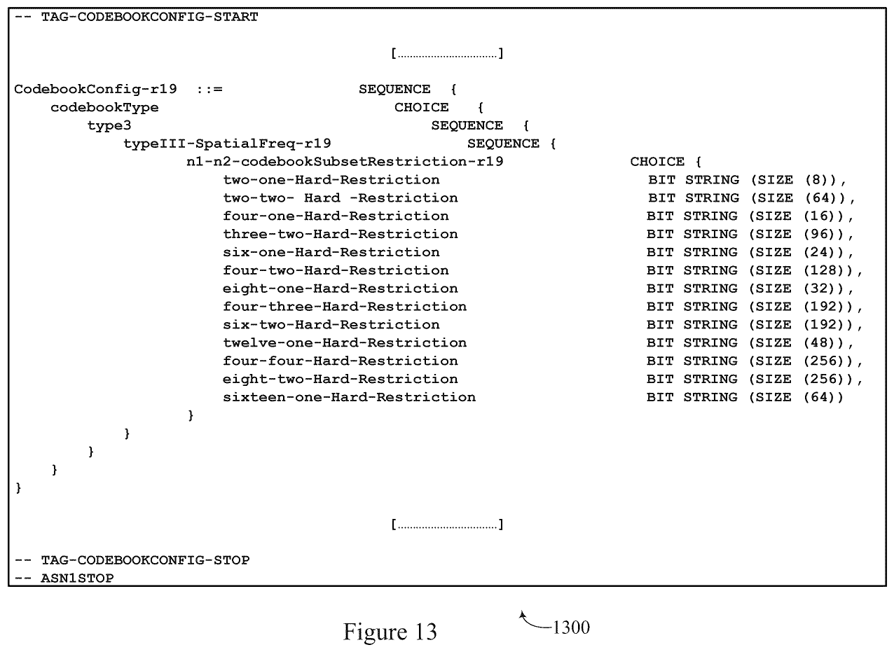

FIG. 13 illustrates an example IE 1300 in accordance with aspects of the present disclosure. The IE 1300 includes an example of the ASN.1 code corresponding to hard restriction for the CodebookConfig Codebook Configuration IE.

Additionally or alternatively, the CBSR is also referred to as beam restriction, precoder restriction, precoding vector restriction, precoding matrix restriction, PMI restriction, CSI restriction, interference restriction, inter-cell interference restriction, leakage restriction, beam restriction, correlation restriction, similarity restriction, or a combination thereof.

Returning to FIG. 1, in order to achieve the targeted restriction on the PMI, e.g., CBSR, a pre-configured set of restriction vectors is defined, where the network may restrict a subset of the set of restriction vectors (also referred to as CBSR vectors). Various implementations of the set of restriction vectors are described below. A combination of one or more of these implementations may also be used.

In one or more implementations, the pre-configured set of restriction vectors comprises a set of columns of a standard transformation matrix. In one example, the standard transformation matrix corresponds to a Fourier-based matrix, e.g., DFT matrix with one or more phase offset values corresponding to oversampling factors of the DFT matrix. In another example, the standard transformation matrix corresponds to a Sinusoidal-transform-based matrix, e.g., Discrete Cosine Transform (DCT) matrix or Discrete Sine Transform (DST), with one or more phase offset values corresponding to oversampling factors of the DFT matrix. In another example, the standard transformation matrix corresponds to a wavelet-transform-based matrix, e.g., Discrete Wavelet Transform (DWT) matrix

In one or more implementations, the subset of the set of restriction vectors comprises N′ vectors selected from the set of N restriction vectors, and N′≤N. The following examples are provided, where a matrix C corresponds to the subset of the set of restriction vectors including N′ vectors. In one example, the matrix C is a one-dimensional DFT matrix transformation:

$$\begin{matrix}{f}_{k} = {[ \begin{matrix}1 & {e}^{j \frac{2 π k}{N}} & … & {e}^{j \frac{2 π k ( N - 1 )}{N}}\end{matrix} ]}^{T} , & 0 \leq k \leq N - 1 \\ C = [ \begin{matrix}{f}_{{k}_{o}} & {f}_{{k}_{1}} & … & {f}_{{k}_{N - 1}} ]\end{matrix} , & 0 \leq {k}_{i} \leq N - 1\end{matrix}$$

In another example, the matrix C is an oversampled one-dimensional DFT matrix transformation:

$$\begin{matrix}{f}_{k} = {[ \begin{matrix}1 & {e}^{j \frac{2 π k}{N}} & … & {e}^{j \frac{2 π k ( N - 1 )}{N}}\end{matrix} ]}^{T} , & 0 \leq k \leq ON - 1 , \\ C = [ \begin{matrix}{f}_{{k}_{o}} & {f}_{{k}_{1}} & … & {f}_{{k}_{{N}^{′} - 1}} ]\end{matrix} , & 0 \leq {k}_{i} \leq N - 1 ,\end{matrix}$$

$${k}_{i} = {On}^{( i )} + q , 0 \leq {n}^{( i )} < N , 0 \leq q < O ,$$

In another example, the matrix C is a one-dimensional DCT matrix transformation:

$$\begin{matrix}{f}_{k} = \sqrt{\frac{1 + ⌈ \frac{k}{N} ⌉}{N}} \cdot {[ \begin{matrix}cos \frac{k π}{2 N} & cos \frac{3 k π}{2 N} & … & cos \frac{( 2 N - 1 ) k π}{2 N}\end{matrix} ]}^{T} , & 0 \leq k \leq N - 1 \\ C = [ \begin{matrix}{f}_{{k}_{o}} & {f}_{{k}_{1}} & … & {f}_{{k}_{{N}^{′} - 1}}\end{matrix} ] , & 0 \leq {k}_{i} \leq N - 1\end{matrix}$$

In another example, the matrix C is a one-dimensional DST matrix transformation:

$$\begin{matrix}{f}_{k} = \sqrt{\frac{1 + ⌈ \frac{k}{N} ⌉}{N}} \cdot {[ \begin{matrix}sin \frac{k π}{2 N} & sin \frac{3 k π}{2 N} & … & sin \frac{( 2 N - 1 ) k π}{2 N}\end{matrix} ]}^{T} , & 0 \leq k \leq N - 1 \\ C = [ \begin{matrix}{f}_{{k}_{o}} & {f}_{{k}_{1}} & … & {f}_{{k}_{{N}^{′} - 1}}\end{matrix} ] , & 0 \leq {k}_{i} \leq N - 1\end{matrix}$$

In one or more implementations, the set of restriction vectors is based on a standard transformation matrix that transforms two dimensions, e.g., joint time/Doppler domain and frequency domain. The following examples are provided. In one example, the set of restriction vectors is based on a two-dimensional DFT matrix transformation:

$$\begin{matrix}{f}_{k} = {[ \begin{matrix}1 & {e}^{j \frac{2 π k}{{N}_{1}}} & … & {e}^{j \frac{2 π k ( {N}_{1} - 1 )}{{N}_{1}}}\end{matrix} ]}^{T} , & 0 \leq k \leq {N}_{1} - 1 \\ {z}_{δ , k} = {[ \begin{matrix}{f}_{k}^{T} & {e}^{j \frac{2 π δ}{{N}_{2}}} {f}_{k}^{T} & … & {e}^{j \frac{2 π δ}{{N}_{2}}} {f}_{k}^{T} & … & {e}^{j \frac{2 π ( {N}_{2} - 1 )}{{N}_{2}}} {f}_{k}^{T}\end{matrix} ]}^{T} , & 0 \leq δ \leq {N}_{2} - 1 \\ C = [ \begin{matrix}{z}_{{δ}_{o} , {k}_{o}} & {z}_{{δ}_{1} , {k}_{1}} & … & {z}_{{δ}_{{N}^{′} - 1} , {k}_{{N}^{′} - 1}} ]\end{matrix} , & 0 \leq {k}_{i} \leq {N}_{1} - 1 , 0 \leq {δ}_{i} \leq {N}_{2} - 1\end{matrix}$$

In another example, the set of restriction vectors is based on an oversampled two-dimensional DFT matrix transformation:

$$\begin{matrix}\begin{matrix}{f}_{k} = {[ \begin{matrix}1 & {e}^{j \frac{2 π k}{{O}_{1} {N}_{1}}} & … & {e}^{j \frac{2 π k ( {N}_{1} - 1 )}{{O}_{1} {N}_{1}}}\end{matrix} ]}^{T} , 0 \leq k \leq {O}_{1} {N}_{1} - 1 \\ {z}_{δ , k} = {[ \begin{matrix}{f}_{k}^{T} & {e}^{j \frac{2 π δ}{{O}_{2} {N}_{2}}} {f}_{k}^{T} & … & {e}^{j \frac{2 π δ}{{O}_{2} {N}_{2}}} {f}_{k}^{T} & … & {e}^{j \frac{2 π ( {N}_{2} - 1 )}{{O}_{2} {N}_{2}}} {f}_{k}^{T}\end{matrix} ]}^{T} , \leq δ \leq {O}_{2} {N}_{2} - 1 \\ C = [ \begin{matrix}{z}_{{δ}_{o} , {k}_{o}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {O}_{1} {N}_{1} - 1 ,\end{matrix} \\ 0 \leq {δ}_{i} \leq {O}_{2} {N}_{2} - 1 \\ {k}_{i} = {O}_{1} {n}_{1}^{( i )} + {q}_{1} , 0 \leq {n}_{1}^{( i )} < {N}_{1} , 0 \leq {q}_{1} < {O}_{1} , \\ {δ}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

In another example, the set of restriction vectors is based on a two-dimensional DCT matrix transformation:

$$\begin{matrix}{f}_{k} = \sqrt{\frac{1 + ⌈ \frac{k}{{N}_{3}} ⌉}{{N}_{3}}} \cdot {[ \begin{matrix}cos \frac{k π}{2 {N}_{3}} & cos \frac{3 k π}{2 {N}_{3}} & … & cos \frac{( 2 {N}_{3} - 1 ) k π}{2 {N}_{3}}\end{matrix} ]}^{T} , 0 \leq k \leq {N}_{3} - 1 \\ {z}_{δ , k} = \sqrt{\frac{1 + ⌈ \frac{δ}{{N}_{4}} ⌉}{{N}_{4}}} \cdot {[ \begin{matrix}cos \frac{δ π}{2 {N}_{4}} \cdot {f}_{k}^{T} & cos \frac{3 δ π}{2 {N}_{4}} \cdot {f}_{k}^{T} & … & cos \frac{( 2 {N}_{4} - 1 ) δ π}{2 {N}_{4}} \cdot {f}_{k}^{T}\end{matrix} ]}^{T} , 0 \leq δ \leq {N}_{4} - 1 \\ C = [ \begin{matrix}{z}_{{δ}_{o} , {k}_{o}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {N}_{3} - 1 , 0 \leq {δ}_{i} \leq {N}_{4} - 1\end{matrix}$$

In another example, the set of restriction vectors is based on a two-dimensional DST matrix transformation:

$$\begin{matrix}{f}_{k} = \frac{1 + ⌈ \frac{k}{{N}_{3}} ⌉}{{N}_{3}} \cdot {[ \begin{matrix}sin \frac{k π}{2 {N}_{3}} & sin \frac{3 k π}{2 {N}_{3}} & … & sin \frac{( 2 {N}_{3} - 1 ) k π}{2 {N}_{3}}\end{matrix} ]}^{T} , 0 \leq k \leq {N}_{3} - 1 \\ {Z}_{δ , k} = \sqrt{\frac{1 + ⌈ \frac{δ}{{N}_{4}} ⌉}{{N}_{4}}} \cdot {[ \begin{matrix}sin \frac{δ π}{2 {N}_{4}} \cdot {f}_{k}^{T} & sin \frac{3 δ π}{2 {N}_{4}} \cdot {f}_{k}^{T} & … & sin \frac{( 2 {N}_{4} - 1 ) δ π}{2 {N}_{4}} \cdot {f}_{k}^{T}\end{matrix} ]}^{T} , 0 \leq δ \leq {N}_{4} - 1 \\ C = [ \begin{matrix}{Z}_{{δ}_{o} , {k}_{o}} & {Z}_{{δ}_{1} , {k}_{1}} & … & {Z}_{{δ}_{{N}^{′} - 1} , {k}_{{N}^{′} - 1} ]}\end{matrix} , 0 \leq {k}_{i} \leq {N}_{3} - 1 , 0 \leq {δ}_{i} \leq {N}_{4} - 1\end{matrix}$$

In one or more implementations, the pre-configured set of restriction vectors is selected from a set of precoding vectors received from the UE 104 as part of a prior CSI report. In one example, an indicator including an identification of a selection of the set of precoding vectors from a prior CSI report is signaled as part of the CBSR.

In one or more implementations, the pre-configured set of restriction vectors is selected from a plurality of sets of restriction vectors. In one example, an indicator including an identification of a selection of the set of restriction vectors from the plurality of sets of restriction vectors is signaled as part of the CBSR. In another example, a selection of the set of restriction vectors from the plurality of sets of restriction vectors is inferred from at least one of a capability or a feature associated with the UE 104.

In order to achieve the targeted restriction on the PMI, e.g., CBSR, a pre-configured CBSR metric that measures a correlation value between a candidate precoding vector with the set of restricted CBSR vectors is used. The candidate precoding vector is selected as a precoding vector associated with the PMI value if an output of the CBSR metric corresponding to the correlation value between the selected candidate precoding vector with the set of restricted vectors is less than or equal to a CBSR threshold. Various implementations of a CBSR metric are described below. A combination of one or more of these implementations may also be used.

In one or more implementations, the CBSR metric is based on an average correlation corresponding to a set of frequency sub-bands. In one example, the CBSR metric computes an averaged correlation value over the set of frequency sub-bands, where the CBSR threshold is applied to the averaged correlation value.

In one or more implementations, the CBSR metric is based on a distinct correlation corresponding to each frequency sub-band of a set of frequency sub-bands. In one example, the CBSR metric computes a distinct correlation value for each frequency sub-band of the set of frequency sub-bands, where the CBSR threshold is applied to each correlation value of the set of correlation values associated with the set of frequency sub-bands.

In one or more implementations, the CBSR metric is a based on a magnitude of a normalized standard auto-correlation function. In one example, an averaged CBSR metric corresponding to a candidate precoding vector v associated with a sub-band j and a kth restricted vector u(k) is as follows:

$${A}_{1} = \sqrt{\frac{\frac{1}{B} {\sum }_{j = 1}^{B} \vert {v}_{j}^{H} {u}^{( k )} \vert}{‖ {u}^{( k )} ‖ \cdot \sqrt{\frac{1}{B} {\sum }_{j = 1}^{B} {‖ {v}_{j} ‖}^{2}}}} .$$

In another example, a per sub-band CBSR metric corresponding to a candidate precoding vector v associated with a sub-band j and a kth restricted vector u(k) is as follows:

$${A}_{2 , j} = \sqrt{\frac{\vert {v}_{j}^{H} {u}^{( k )} \vert}{‖ {u}^{( k )} ‖ \cdot ‖ {v}_{j} ‖}}$$

In another example, an averaged CBSR metric corresponding to a candidate precoding vector v associated with a sub-band j and a kth restricted vector u(k) is as follows:

$${A}_{3} = \sqrt{\frac{\frac{1}{B} {\sum }_{j = 1}^{B} \vert {v}_{j}^{H} {u}^{( k )} \vert}{{‖ {u}^{( k )} ‖}^{2} + \frac{1}{B} {\sum }_{j = 1}^{B} {‖ {v}_{j} ‖}^{2}}} .$$

In another example, a per sub-band CBSR metric corresponding to a candidate precoding vector v associated with a sub-band j and a kth restricted vector u(k) is as follows:

$${A}_{4 , j} = \sqrt{\frac{\vert {v}_{j}^{H} {u}^{( k )} \vert}{{‖ {u}^{( k )} ‖}^{2} + {‖ {v}_{j} ‖}^{2}}} .$$

In one or more implementations, a set of CBSR metrics are defined, where one CBSR metric from the set of CBSR metrics is activated or configured by the network.

In order to achieve the targeted restriction on the PMI, e.g., CBSR, a pre-configured codebook of CBSR threshold values is used, where the network may configure each restriction vector from the subset of the set of restriction vectors with a value from the codebook of CBSR threshold values. In one or more implementations, the CBSR threshold values are soft values rather than hard values. Soft values refer to an attenuation factors (e.g., non-zero attenuation factors) that are used to scale (e.g., increase or decrease) an amplitude value for a beam. For example, a CBSR threshold value of \sqrt{1/2} indicates to scale a beam by \sqrt{1/2}. Hard values refer to beam spatial directions, indicating to use or not use a particular beam direction.

Various implementations of CBSR threshold values are described below. A combination of one or more of these implementations may also be used.

In one or more implementations, the pre-configured codebook of CBSR threshold values comprises a plurality of values. In one example, the CBSR threshold value is configured with a CBSR type corresponding to a soft CBSR threshold, or alternatively corresponding to a soft amplitude restriction. In another example, the CBSR threshold value is configured with reporting a parameter corresponding to a soft amplitude restriction being supported, e.g., parameter softAmpRestriction=‘supported’. In another example, the codebook of CBSR threshold values includes at least one or more values of the set {0, \sqrt{1/4}, \sqrt{1/2}, 1}. In another example, the codebook of CBSR threshold values comprises at least one or more values of the set {\sqrt{1}, \sqrt{1/2}, \sqrt{1/3}, \sqrt{1/4}, \sqrt{1/6}, \sqrt{1/8}, \sqrt{1/12}, \sqrt{1/16}}.

In one or more implementations, a UE configured with a set of beams associated with a CBSR corresponding to soft amplitude restriction, e.g., a non-zero attenuation factor for a group of beams, adjusts the CBSR amplitude value based on a number of layers utilizing a beam in the group of beams associated with soft amplitude restriction. In one example, for a beam associated with two layers of a PMI associated with a codebook for CSI feedback, the configured CBSR amplitude value is adjusted via a scaling by a value less than one, e.g., 1/\sqrt{2}, compared with a beam associated with one layer for the PMI associated with a codebook for CSI feedback. More generally, the scaling is 1/\sqrt{K} assuming a beam is used K times, e.g., over K layers, compared with a setup with a single layer associated to a reference beam. In another example, a beam associated with one layer of a PMI associated with a codebook for CSI feedback, the configured CBSR amplitude value is adjusted via a scaling by a value larger than one, e.g., \sqrt{2}, compared with a beam associated with two layers for the PMI associated with a codebook for CSI feedback. More generally, the scaling is \sqrt{K} assuming a beam is used one time, e.g., corresponding to a single layer, compared with a setup with K layers associated with a reference beam.

In one or more implementations, a rank indicator (RI) value is associated with a number of layers corresponding to CSI feedback including PMI, and where the RI value is an odd value, e.g., and where the set of selected spatial domain (SD) basis indices comprises two mutually exclusive subsets of SD basis indices: a first subset of SD basis indices where each SD basis index in the first subset is associated with multiple, e.g., two, layers, and a second subset of SD basis indices where each SD basis index in the second subset is associated with a single layer. Under this setup, a first SD basis index in the second subset, e.g., associated with a single layer, contributes to half of the power of a second SD basis index in the first subset, assuming that a power value allocated to each layer is the same. Given that, a CBSR value configured to the first SD basis index can be adjusted to be multiplied to a value of a square root of one half the value, or a value of one half (in power domain), compared with the second SD basis index, or alternatively, a CBSR value configured to the second SD basis index can be adjusted to be multiplied to a value of a square root of two, or double the value (in power domain), compared with the first SD basis index. In one example, the RI value is an odd value that is larger than 4.

Accordingly, a CBSR mechanism with soft amplitude restriction, e.g., a beam may be restricted via an attenuation of the power with respect to unrestricted beams is discussed herein. The attenuation of restricted beams is based on a number of layers in which the restricted beam is reused across layers if more than one layer is reported within the codebook corresponding to PMI. A UE adjusts a higher-layer configured amplitude restriction corresponding to CBSR based on a selection of the SD basis indices corresponding to the spatial beams associated with the PMI of the codebook.

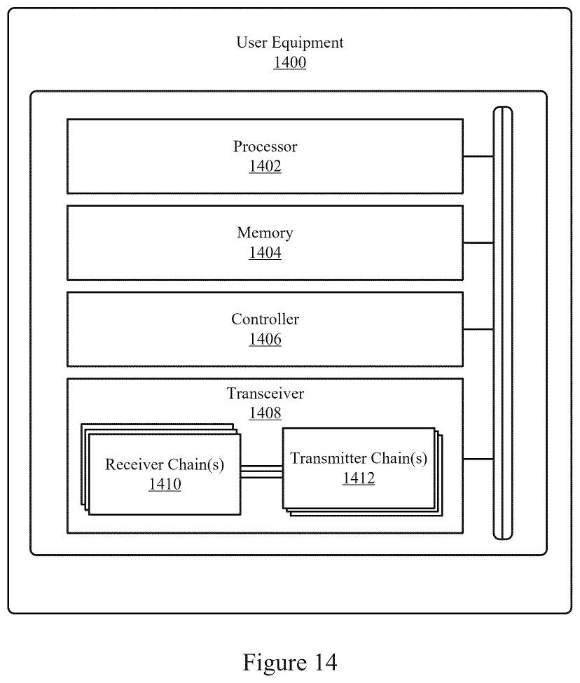

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein. The UE 1400 may be configured to or operable to support a means for receiving a CSI report setting, where the CSI report setting comprises an indication of a CBSR, where an initial amplitude value of a first restricted beam of a set of restricted beams is based at least in part on the CBSR; and adjusting the initial amplitude value of the first restricted beam based at least in part on a number of layers associated with the first restricted beam.

Additionally, the UE 1400 may be configured to support any one or combination of receiving a RS over a NZP CSI-RS resource based at least in part on the CSI report setting; generating a CSI report including a PMI value, where a value of the PMI is based at least in part on the NZP CSI-RS resource and the CBSR; and transmitting the CSI report including the PMI; where the set of restricted beams comprises at least one subset of restricted beams, and where the at least one subset of restricted beams is associated with an amplitude restriction value applicable for each restricted beam in the at least one subset of restricted beams; where the adjusting the initial amplitude value of the first restricted beam comprises applying a scaling factor to the initial amplitude value of the first restricted beam, where the scaling factor corresponds to an amplitude restriction value, and where the scaling factor comprises a non-negative value less than or equal to one; where the first restricted beam is associated with two layers of a PMI associated with a codebook for CSI feedback and adjusting the initial amplitude value of the first restricted beam by scaling the amplitude value of the first restricted beam by an inverse of a square root value of 2; and leaving a second restricted beam associated with a single layer of a PMI associated with the codebook for CSI feedback unadjusted; where the first restricted beam is associated with a single layer of a PMI associated with a codebook for CSI feedback and adjusting the initial amplitude of the first restricted beam by scaling the amplitude value of the first restricted beam by a square root value of 2; and leaving a second restricted beam associated with two layers of a PMI associated with the codebook for CSI feedback unadjusted; identifying a restriction for the amplitude value of the first restricted beam based at least in part on a metric associated with the CBSR; and separately applying the restriction for the amplitude value of the first restricted beam on each frequency band of one or more frequency bands associated with a PMI; where a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

Additionally, or alternatively, the UE 1400 may support at least one memory (e.g., the memory 1404) and at least one processor (e.g., the processor 1402) coupled with the at least one memory and configured to cause the UE to: receive a CSI report setting, where the CSI report setting comprises an indication of a CBSR, where an initial amplitude value of a first restricted beam of a set of restricted beams is based at least in part on the CBSR; and adjust the initial amplitude value of the first restricted beam based at least in part on a number of layers associated with the first restricted beam.

Additionally, the UE 1400 may be configured to support any one or combination of the at least one processor is configured to receive a RS over a NZP CSI-RS resource based at least in part on the CSI report setting; generate a CSI report including a PMI, where a value of the PMI is based at least in part on the NZP CSI-RS resource and the CBSR; and transmit the CSI report including the PMI; where the set of restricted beams comprises at least one subset of restricted beams, and where the at least one subset of restricted beams is associated with an amplitude restriction value applicable for each restricted beam in the at least one subset of restricted beams; apply a scaling factor to the initial amplitude value of the first restricted beam, where the scaling factor corresponds to an amplitude restriction value, and where the scaling factor comprises a non-negative value less than or equal to one; where the first restricted beam is associated with two layers of a PMI associated with a codebook for CSI feedback and adjust the initial amplitude value of the first restricted beam by scaling the amplitude value of the first restricted beam by an inverse of a square root value of 2; and leaving a second restricted beam associated with a single layer of a PMI associated with the codebook for CSI feedback unadjusted; where the first restricted beam is associated with a single layer of a PMI associated with a codebook for CSI feedback and adjust the initial amplitude of the first restricted beam by scaling the amplitude value of the first restricted beam by a square root value of 2; and leaving a second restricted beam associated with two layers of a PMI associated with the codebook for CSI feedback unadjusted; identify a restriction for the amplitude value of the first restricted beam based at least in part on a metric associated with the CBSR; and separately apply the restriction for the amplitude value of the first restricted beam on each frequency band of one or more frequency bands associated with a PMI; where a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

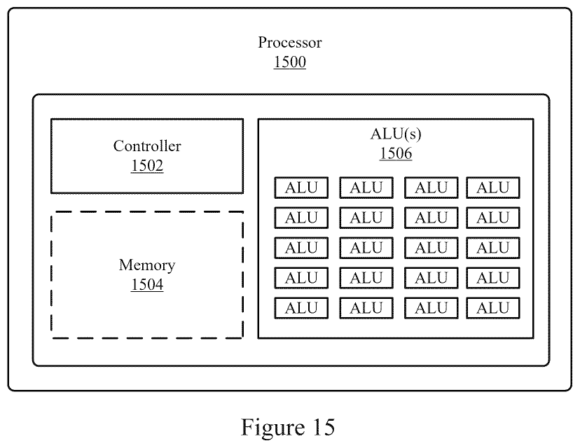

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to: receive a CSI report setting, where the CSI report setting comprises an indication of a CBSR, where an initial amplitude value of a first restricted beam of a set of restricted beams is based at least in part on the CBSR; and adjust the initial amplitude value of the first restricted beam based at least in part on a number of layers associated with the first restricted beam.

Additionally, the processor 1500 may be configured to or operable to support any one or combination of the at least one controller is configured to cause the processor to receive a RS over a NZP CSI-RS resource based at least in part on the CSI report setting; generate a CSI report including a PMI, where a value of the PMI is based at least in part on the NZP CSI-RS resource and the CBSR; and transmit the CSI report including the PMI; where the set of restricted beams comprises at least one subset of restricted beams, and where the at least one subset of restricted beams is associated with an amplitude restriction value applicable for each restricted beam in the at least one subset of restricted beams; where, to adjust the initial amplitude value, apply a scaling factor to the initial amplitude value of the first restricted beam, where the scaling factor corresponds to an amplitude restriction value, and where the scaling factor comprises a non-negative value less than or equal to one; where the first restricted beam is associated with two layers of a PMI associated with a codebook for CSI feedback and adjust the initial amplitude value of the first restricted beam by scaling the amplitude value of the first restricted beam by an inverse of a square root value of 2; and leaving a second restricted beam associated with a single layer of a PMI associated with the codebook for CSI feedback unadjusted; where the first restricted beam is associated with a single layer of a PMI associated with a codebook for CSI feedback and adjust the initial amplitude of the first restricted beam by scaling the amplitude value of the first restricted beam by a square root value of 2; and leaving a second restricted beam associated with two layers of a PMI associated with the codebook for CSI feedback unadjusted; identify a restriction for the amplitude value of the first restricted beam based at least in part on a metric associated with the CBSR; and separately apply the restriction for the amplitude value of the first restricted beam on each frequency band of one or more frequency bands associated with a PMI; where a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

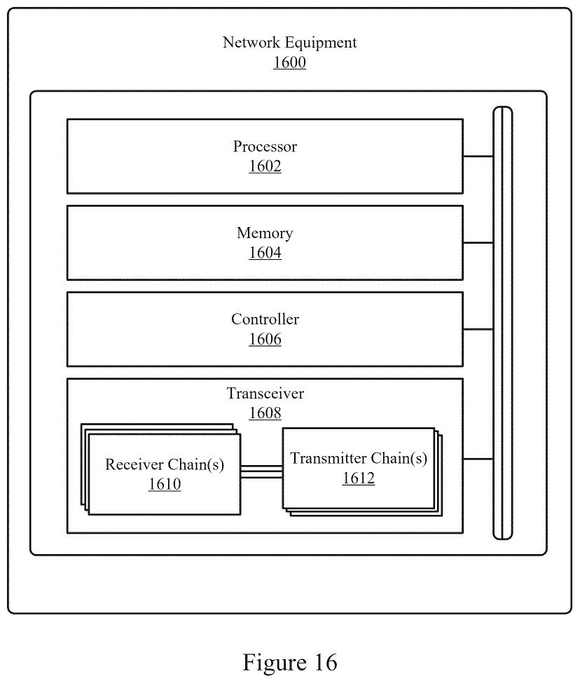

FIG. 16 illustrates an example of a NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The NE 1600 may be configured to support a means for transmitting a CSI report setting, where the CSI report setting comprises an indication of a CBSR on a PMI; transmitting a RS over a NZP CSI-RS resource based at least in part on the CSI report setting; and receiving a CSI report including a PMI, where a value of the PMI is based at least in part on the NZP CSI-RS resource and the CBSR, and where an amplitude value associated with the CBSR has been adjusted based at least in part on a number of layers associated with a beam in a set of restricted beams.

Additionally, the NE 1600 may be configured to support any one or combination of where the CBSR comprises the set of restricted beams configured by the base station, where the set of restricted beams is associated with a set of restriction values, and where the set of restriction values corresponds to a codebook of amplitude restriction values; where a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

Additionally, or alternatively, the NE 1600 may support at least one memory (e.g., the memory 1604) and at least one processor (e.g., the processor 1602) coupled with the at least one memory and configured to cause the NE to: transmit a CSI report setting, where the CSI report setting comprises an indication of a CBSR on a PMI; transmit a RS over a NZP CSI-RS resource based at least in part on the CSI report setting; and receive a CSI report including a PMI, where a value of the PMI is based at least in part on the NZP CSI-RS resource and the CBSR, and where an amplitude value associated with the CBSR has been adjusted based at least in part on a number of layers associated with a beam in a set of restricted beams.

Additionally, the NE 1600 may be configured to support any one or combination of the at least one processor is configured to cause the NE to where the CBSR comprises the set of restricted beams configured by the base station, where the set of restricted beams is associated with a set of restriction values, and where the set of restriction values corresponds to a codebook of amplitude restriction values; where a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

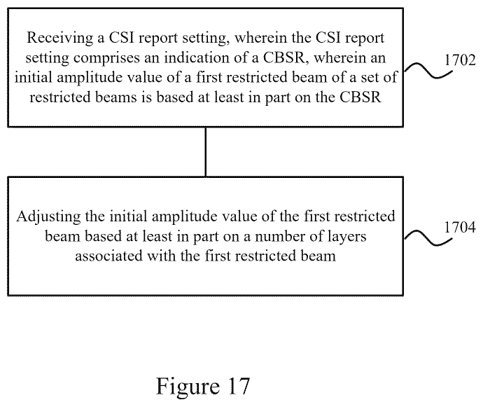

FIG. 17 illustrates a flowchart of a method in accordance with aspects of the present disclosure. The operations of the method may be implemented by a UE as described herein. In some implementations, the UE may execute a set of instructions to control the function elements of the UE to perform the described functions.

At 1702, the method may include receiving a CSI report setting, wherein the CSI report setting comprises an indication of a CBSR, wherein an initial amplitude value of a first restricted beam of a set of restricted beams is based at least in part on the CBSR. The operations of 1702 may be performed in accordance with examples as described herein. In some implementations, aspects of the operations of 1702 may be performed by a UE as described with reference to FIG. 14.

At 1704, the method may include adjusting the initial amplitude value of the first restricted beam based at least in part on a number of layers associated with the first restricted beam. The operations of 1704 may be performed in accordance with examples as described herein. In some implementations, aspects of the operations of 1704 may be performed by a UE as described with reference to FIG. 14.

It should be noted that the method described herein describes a possible implementation, and that the operations and the steps may be rearranged or otherwise modified and that other implementations are possible.

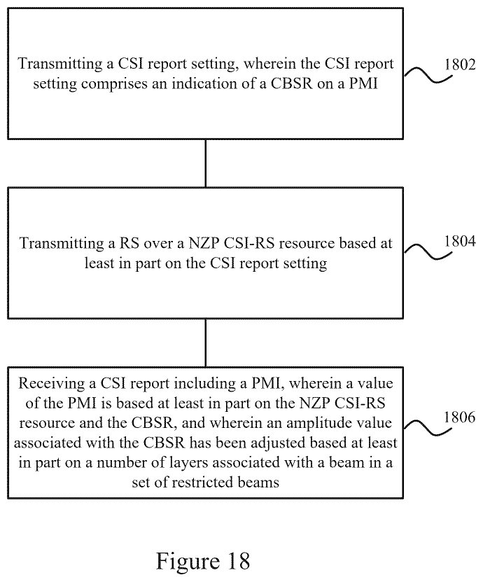

FIG. 18 illustrates a flowchart of a method in accordance with aspects of the present disclosure. The operations of the method may be implemented by a NE as described herein. In some implementations, the NE may execute a set of instructions to control the function elements of the NE to perform the described functions.

At 1802, the method may include transmitting a CSI report setting, wherein the CSI report setting comprises an indication of a CBSR on a PMI. The operations of 1802 may be performed in accordance with examples as described herein. In some implementations, aspects of the operations of 1802 may be performed by a NE as described with reference to FIG. 16.

At 1804, the method may include transmitting a RS over a NZP CSI-RS resource based at least in part on the CSI report setting. The operations of 1804 may be performed in accordance with examples as described herein. In some implementations, aspects of the operations of 1804 may be performed by a NE as described with reference to FIG. 16.

At 1806, the method may include receiving a CSI report including a PMI, wherein a value of the PMI is based at least in part on the NZP CSI-RS resource and the CBSR, and wherein an amplitude value associated with the CBSR has been adjusted based at least in part on a number of layers associated with a beam in a set of restricted beams. The operations of 1806 may be performed in accordance with examples as described herein. In some implementations, aspects of the operations of 1806 may be performed a NE as described with reference to FIG. 16.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a channel state information (CSI) report setting, wherein the CSI report setting comprises an indication of a codebook subset restriction (CBSR), wherein an initial amplitude value of a first restricted beam of a set of restricted beams is based at least in part on the CBSR; and
adjust the initial amplitude value of the first restricted beam based at least in part on a number of layers associated with the first restricted beam.

2. The UE of claim 1, wherein the at least one processor is further configured to cause the UE to:
receive a reference signal (RS) over a non-zero power (NZP) CSI-RS resource based at least in part on the CSI report setting;
generate a CSI report including a precoding matrix indicator (PMI), wherein a value of the PMI is based at least in part on the NZP CSI-RS resource and the CBSR; and
transmit the CSI report including the PMI.

3. The UE of claim 1, wherein the set of restricted beams comprises at least one subset of restricted beams, and wherein the at least one subset of restricted beams is associated with an amplitude restriction value applicable for each restricted beam in the at least one subset of restricted beams.

4. The UE of claim 1, wherein, to adjust the initial amplitude value, the at least one processor is further configured to cause the UE to:
apply a scaling factor to the initial amplitude value of the first restricted beam, wherein the scaling factor corresponds to an amplitude restriction value, and wherein the scaling factor comprises a non-negative value less than or equal to one.

5. The UE of claim 1, wherein the first restricted beam is associated with two layers of a precoding matrix indicator (PMI) associated with a codebook for CSI feedback and the at least one processor is further configured to cause the UE to:
adjust the initial amplitude value of the first restricted beam by scaling the amplitude value of the first restricted beam by an inverse of a square root value of 2; and
leave a second restricted beam associated with a single layer of a PMI associated with the codebook for CSI feedback unadjusted.

6. The UE of claim 1, wherein the first restricted beam is associated with a single layer of a precoding matrix indicator (PMI) associated with a codebook for CSI feedback and the at least one processor is further configured to cause the UE to:
adjust the initial amplitude of the first restricted beam by scaling the amplitude value of the first restricted beam by a square root value of 2; and
leave a second restricted beam associated with two layers of a PMI associated with the codebook for CSI feedback unadjusted.

7. The UE of claim 1, wherein the at least one processor is further configured to cause the UE to:
identify a restriction for the amplitude value of the first restricted beam based at least in part on a metric associated with the CBSR; and
separately apply the restriction for the amplitude value of the first restricted beam on each frequency band of one or more frequency bands associated with a precoding matrix indicator (PMI).

8. The UE of claim 1, wherein a first adjustment of a first amplitude value associated with the first beam in the set of restricted beams comprises an attenuation by a greater amount than a second adjustment of a second amplitude value associated with a second beam in the set of restricted beams in response to a first number of layers associated with the first beam being larger than a second number of layers associated with the second beam.

9. A processor for wireless communication, comprising:
at least one controller coupled with at least one memory and configured to cause the processor to:
receive a channel state information (CSI) report setting, wherein the CSI report setting comprises an indication of a codebook subset restriction (CBSR), wherein an initial amplitude value of a first restricted beam of a set of restricted beams is based at least in part on the CBSR; and
adjust the initial amplitude value of the first restricted beam based at least in part on a number of layers associated with the first restricted beam.

10. The processor of claim 9, wherein the at least one controller is further configured to cause the processor to:
receive a reference signal (RS) over a non-zero power (NZP) CSI-RS resource based at least in part on the CSI report setting;
generate a CSI report including a precoding matrix indicator (PMI), wherein a value of the PMI is based at least in part on the NZP CSI-RS resource and the CBSR; and
transmit the CSI report including the PMI.

11. The processor of claim 9, wherein the set of restricted beams comprises at least one subset of restricted beams, and wherein the at least one subset of restricted beams is associated with an amplitude restriction value applicable for each restricted beam in the at least one subset of restricted beams.

12. The processor of claim 9, wherein, to adjust the initial amplitude value, the at least one controller is further configured to cause the processor to:
apply a scaling factor to the initial amplitude value of the first restricted beam, wherein the scaling factor corresponds to an amplitude restriction value, and wherein the scaling factor comprises a non-negative value less than or equal to one.

13. The processor of claim 9, wherein the first restricted beam is associated with two layers of a precoding matrix indicator (PMI) associated with a codebook for CSI feedback and the at least one controller is further configured to cause the processor to:
adjust the initial amplitude value of the first restricted beam by scaling the amplitude value of the first restricted beam by an inverse of a square root value of 2; and
leave a second restricted beam associated with a single layer of a PMI associated with the codebook for CSI feedback unadjusted.

14. The processor of claim 9, wherein the first restricted beam is associated with a single layer of a precoding matrix indicator (PMI) associated with a codebook for CSI feedback and the at least one controller is further configured to cause the processor to:
adjust the initial amplitude of the first restricted beam by scaling the amplitude value of the first restricted beam by a square root value of 2; and
leave a second restricted beam associated with two layers of a PMI associated with the codebook for CSI feedback unadjusted.

15. The processor of claim 9, wherein the at least one controller is further configured to cause the processor to:
identify a restriction for the amplitude value of the first restricted beam based at least in part on a metric associated with the CBSR; and
separately apply the restriction for the amplitude value of the first restricted beam on each frequency band of one or more frequency bands associated with a precoding matrix indicator (PMI).

16. A base station for wireless communication, comprising:
at least one memory; and
at least one processor coupled with the at least one memory and configured to cause the base station to:
transmit a channel state information (CSI) report setting, wherein the CSI report setting comprises an indication of a codebook subset restriction (CBSR) on a precoding matrix indicator (PMI);
transmit a reference signal (RS) over a non-zero power (NZP) CSI-RS resource based at least in part on the CSI report setting; and
receive a CSI report including a PMI, wherein a value of the PMI is based at least in part on the NZP CSI-RS resource and the CBSR, and wherein an amplitude value associated with the CBSR has been adjusted based at least in part on a number of layers associated with a beam in a set of restricted beams.

17. The base station of claim 16, wherein the CBSR comprises the set of restricted beams configured by the base station, wherein the set of restricted beams is associated with a set of restriction values, and wherein the set of restriction values corresponds to a codebook of amplitude restriction values.

18. A method performed by a user equipment (UE), the method comprising:
receiving a channel state information (CSI) report setting, wherein the CSI report setting comprises an indication of a codebook subset restriction (CBSR), wherein an initial amplitude value of a first restricted beam of a set of restricted beams is based at least in part on the CBSR; and
adjusting the initial amplitude value of the first restricted beam based at least in part on a number of layers associated with the first restricted beam.

19. The method of claim 18, further comprising:
receiving a reference signal (RS) over a non-zero power (NZP) CSI-RS resource based at least in part on the CSI report setting;
generating a CSI report including a PMI value, wherein a value of the PMI is based at least in part on the NZP CSI-RS resource and the CBSR; and
transmitting the CSI report including the PMI.

20. The method of claim 18, wherein the adjusting the initial amplitude value of the first restricted beam comprises applying a scaling factor to the initial amplitude value of the first restricted beam, wherein the scaling factor corresponds to an amplitude restriction value, and wherein the scaling factor comprises a non-negative value less than or equal to one.
